(19) United States
(12) Patent Application Publication
(10) Pub. No.: US 2012/0304841 A1
(43) Pub. Date: Dec. 6, 2012

(54) Spacer for Cut-Off Wheel

(76) Inventor: Tracey A. Bort, Kirkville, NY (US)

(21) Appl. No.: 13/588,001

(22) Filed: Aug. 17, 2012

Related U.S. Application Data
(63) Continuation-in-part of application No. 12/456,410, filed on Jun. 16, 2009.

(51) Int. Cl. B26D 1/12

(52) U.S. Cl. 83/665

(57) ABSTRACT

A spacer disc is placed onto the drive shaft of a hand-held grinder to position a cut-off disc or cut-off wheel at or beyond the end of the shaft. An annular insert at the proximal face is placed against the backing plate and a concave distal face is positioned against the cut-off disc. The spacer disc is composed of a spacer body of semi-rigid material with an open axial core. A flanged retainer nut secures the cut-off disc onto the grinder shaft against the distal face of the spacer disc. This arrangement permits the tool to be held with the cut-off disc flush to a flat workpiece surface.

This is a continuation-in-part of my co-pending patent application Ser. No. 12/456,410, filed Jun. 16, 2009, the contents of which are incorporated by reference herein.

### BACKGROUND OF THE INVENTION

This invention relates to an improvement to power tools, namely, so-called angle grinders or disc grinders, and in particular to an improvement for mounting an abrasive disc such as a cutting wheel or a cut-off disc onto the rotary shaft of the grinder so that the tool can be used to make cuts flush with a workpiece surface.

Angle grinders are hand-held power tools, with a geared head situated at a right angle to the main body of the tool, so that the abrasive disc can be mounted on the side of the tool. These grinders may be electric, pneumatic, or fuel-powered.

Cut-off discs or cut-off wheels are typically composed of a thin fibrous abrasive material, and are mounted onto the shaft of the grinder between a backing plate and a flanged retainer nut. This results in an end portion of the rotary shaft projecting out beyond the plane of the cut-off disc. The protruding shaft and retaining nut make it difficult to remove material that is welded or attached onto a flat surface of the workpiece, because the tool cannot be held with the cut-off disc flush to the workpiece. Instead, the grinder has to be held with the cut-off disc at an angle to the flat workpiece surface. This places the cut-off disc where it cuts out material from below the surface of workpiece, and requiring an additional step of welding in replacement material which must then be ground down flush.

This problem has existed since cut-off discs have been in use, but to date no one has come up with an effective way to work with the grinder to place the cut-off disc flush with the plane of the workpiece, and avoid the aforementioned damage to the workpiece.

### OBJECTS AND SUMMARY OF THE INVENTION

Accordingly, it is an object to provide a mounting arrangement for securing a cut-off disc or cut-off wheel onto the shaft of a hand-held grinder tool, so as to avoid the drawbacks mentioned hereinabove.

A more specific object of this invention is to provide a mounting arrangement that places the cut-off disc or cut-off wheel at or beyond the distal end of the rotary shaft of the grinder tool, so that the grinder can be held with the cut-off disc flush with a flat workpiece surface.

Another object is to provide the mounting arrangement as a simple-to-install-and-use article that can be employed with an existing angle grinder and an existing cut-off disc to achieve the desired results.

According to an aspect of the present invention, an attachment is provided for securing a cut-off disc onto the drive shaft of the hand-held power grinder device, employing also the backing plate that is provided and secured at a predetermined position onto the shaft.

A spacer disc is of a suitable thickness and diameter to be positioned on the shaft. The spacer disc has a proximal face that is placed against the backing plate and a distal face which is positioned against a proximal side of the cut-off disc. The spacer disc is composed of a spacer body of stiff, but somewhat giving material, e.g., a semi-rigid plastic resin, and has an open core into which the grinder shaft passes. The distal side of the spacer disc body, which serves as the distal face of the spacer, is at least slightly dished-in or concave. There is a durable rigid annular insert, e.g., a steel washer, embedded in spacer body at its proximal face and the insert has its central aperture coaxial with the open core of the spacer body.

A flanged retainer nut is provided for securing the cut-off disc onto the grinder shaft against the distal face of the spacer disc. This has a nut portion, e.g., a female threaded tube, that is to be secured onto the distal end of the grinder drive shaft and this fits within the open core of the spacer disc. A flange at the distal end of the retainer nut presses against the distal side of the cut-off disc. The flange cooperates with the concave face of the spacer disc such that the flange of the nut and the distal end of the shaft are positioned at or proximally of (i.e., above) the plane of the cut-off disc. The flange of the retainer nut is favorably provided with holes or openings to receive a standard spanner tool for tightening or loosening the nut on the grinder shaft.

Preferably, the spacer body has a tapered circumferential surface, i.e., somewhat conic or flared. The spacer disc is suitably dimensioned for the specific angle grinder, but for most typical arrangements, the spacer disc may have a thickness between its proximal and distal faces of substantially about a half inch to an inch.

These and other objects, features, and advantages of the invention will become apparent from the following detailed description of a selected preferred embodiment, which is to be read in connection with the accompanying Drawing:

### BRIEF DESCRIPTION OF THE DRAWING

FIG. 1 is a side view that shows an angle grinder with a cut-off disc or cut-off wheel mounted thereon, employing the mounting arrangement of the prior art.

FIG. 2 is a side view of a grinder and cut-off disc showing the cut-off disc mounting arrangement according to an embodiment of this invention.

FIG. 3 is a top plan view of the spacer disc of this embodiment.

FIG. 4 is a sectional view taken at line 4-4 of FIG. 3.

FIG. 5 is a sectional view of the mounting arrangement, with the grinder tool, drive shaft, and cut-off disc being shown in broken line.

FIGS. 6 and 7 are perspective views of the spacer disc of this embodiment from the proximal and distal sides thereof, respectively.

FIG. 8 is an assembly view of the grinder, spacer disc, cut-off disc, and retainer nut of this embodiment.

### DETAILED DESCRIPTION OF THE PREFERRED EMBODIMENT

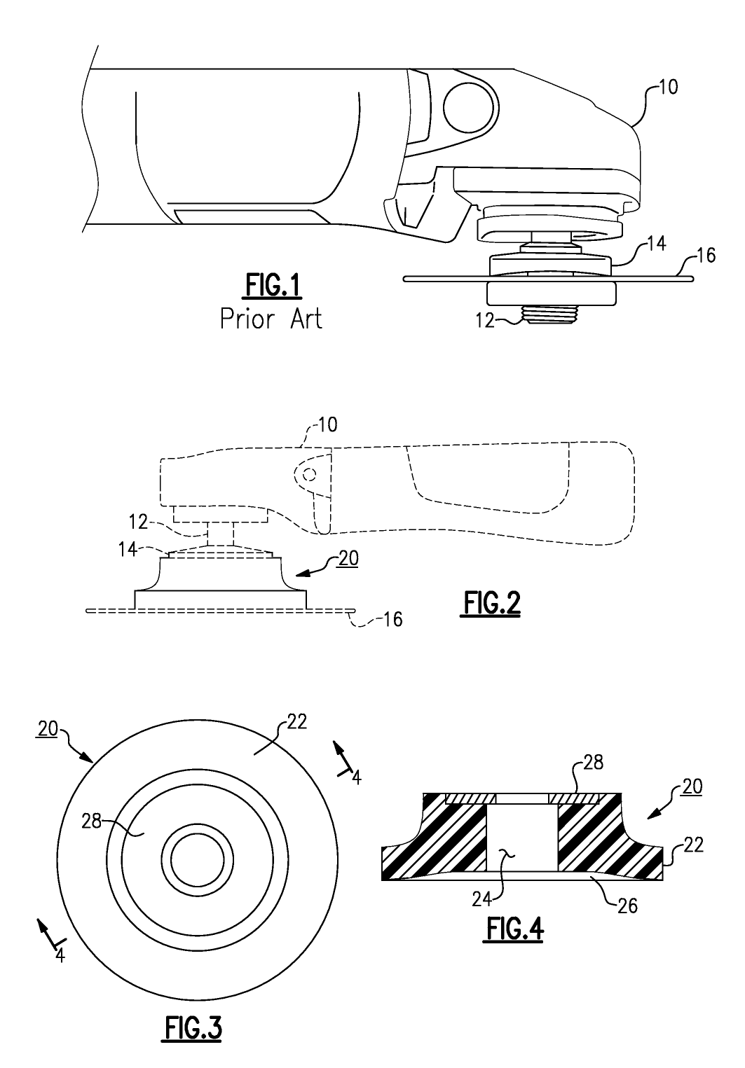

With reference to the Drawing Figures, an arrangement according to the prior art is illustrated in FIG. 1. A hand-held angle grinder 10 here is shown with its rotary drive shaft 12 extending down to one side, with a backing plate 14 mounted on the shaft 12. Typically, the position of the backing plate 14 on the shaft can be adjusted, within limits. In this prior art arrangement, a standard cut-off disc 16 is held in place by a retainer plate 18, so that the cut-off disc 16 is held between the backing plate 14 and the retainer plate 18. The retainer plate may be secured using a threaded nut (not shown here). The cut-off disc 16 may be a circular member formed of a fibrous abrasive material, with a nominal thickness of ⅛ inch, but which may be in the range of e.g. 1/16 inch to 11/32 inches. Here the cut-off disc has a diameter of about 4½ inches, but cut-off discs are available in a variety of sizes, larger and smaller than what is shown here, depending on the application and depending on the size of the hand-held grinder 10.

The improvement of the present invention can be seen in the remaining drawing Figures, beginning with FIGS. 2, 3, and 4. A spacer disc 20 is positioned on the drive shaft 12 of the angle grinder 10 with the cut-off disc 16 being held in place against a lower or distal surface of the spacer 20. This offsets the plane of the cut-off disc 16 to the distal end of the shaft 12 so that the shaft does not interfere with holding the cut-off disc 16 flush with a workpiece surface.

As shown in FIGS. 3 and 4, the spacer disc 20 has a spacer body 22, here formed of a tough, durable semi-rigid plastic resin material, with an open generally cylindrical core or void 24 to accommodate the drive shaft 12 of the associated grinder 10. A lower, or distal face 26 of the spacer body 22 is concave, that is, somewhat dished-in or recessed. At the upper or proximal side of the spacer disc 20, an annular metal insert 28, i.e., a steel washer, is embedded in the spacer body 22, here with its central opening or aperture aligned coaxial with the open core 24. The side or circumferential surface of the spacer body is somewhat tapered, that is, flared, so that it is wider at the distal face and narrower at the proximal face.

As shown in FIG. 5, the spacer disc 20 is installed on the grinder 10 with its upper or proximal face towards the backing plate 14, so that the insert 28 fits over the shaft 12 and is held against the backing plate 14, with the grinder shaft 12 extending down into along the axis of the open core 24. A flanged retaining nut 30 secures the cut-off disc 16 against the distal or lower face 26 of the spacer disc, with the nut 30 being secured onto the threaded shaft, and with its flanged portion holding the cut-off disc within the recess or concave face 26 of the spacer disc.

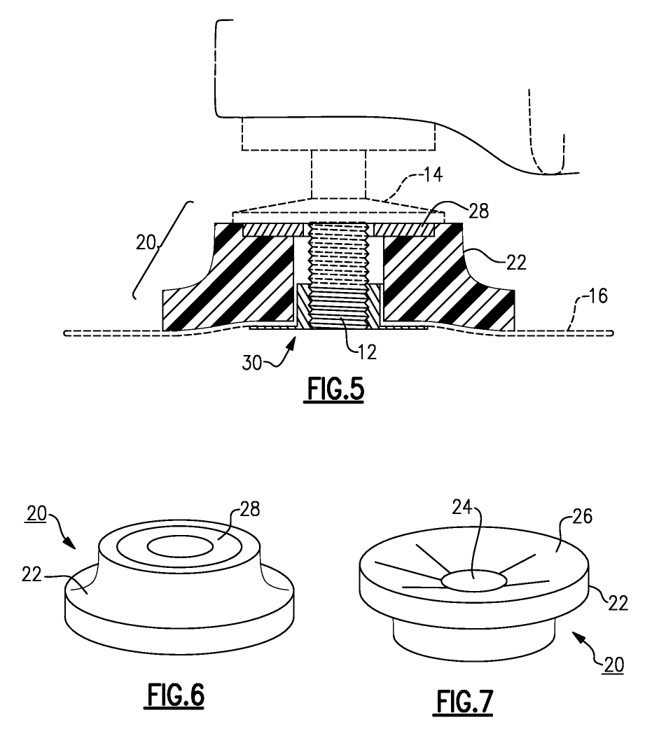

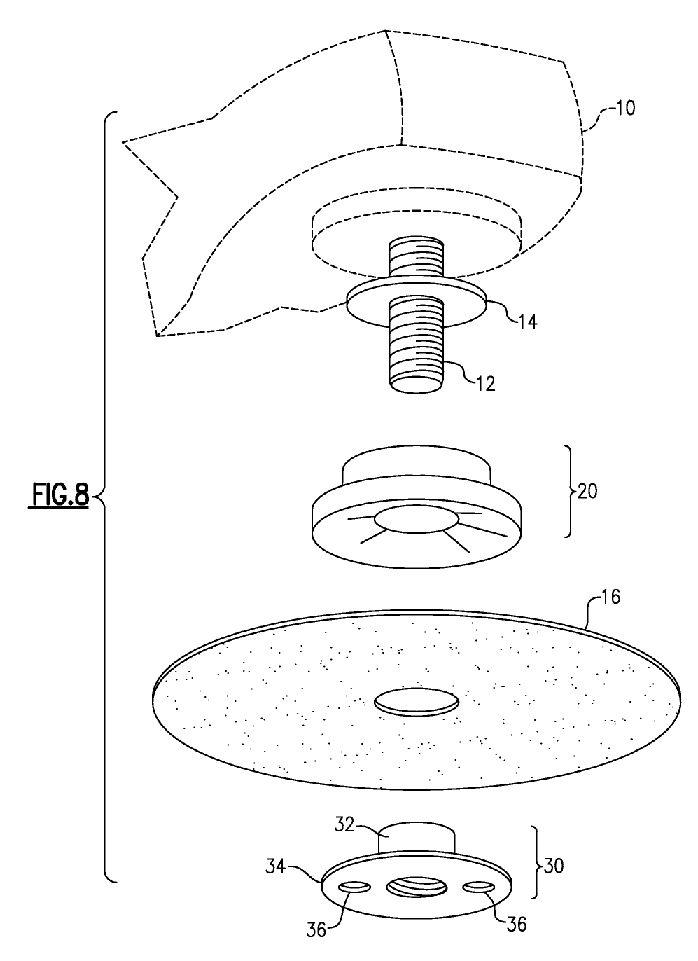

FIGS. 6 and 7 provide perspective views of the spacer disc 20 of this embodiment, from a proximal or upper side thereof, and from the distal or lower side thereof, respectively, and illustrate the insert 28 as well as the central open core 24 and concave face 26.

The assembly or installation of the cut-off disc 16 onto the angle grinder 10 can be explained with reference to FIG. 8. With the backing plate 14 suitably positioned on the grinder shaft 12, the spacer disc 20 is installed with the insert 28 facing up or proximal, against the backing plate 14. The concave face 26 is disposed down or distally, and the shaft 14 extends into the open core 24 of the spacer disc 20, but not past the distal face of the spacer disc. The retaining nut 30 then secures the cut-off disc 16 against the spacer disc 20.

Here, the retaining nut is shown as a flanged nut, with a generally cylindrical or tubular female-threaded member 32 that mates with the threads of the drive shaft 12, and also has a flat, annular disc flange 34 that captures the cut-off disc 16 by securing against its lower or distal side. The tubular threaded member 32 fits into the central opening provided in the cut-off disc 16, and also fits into the annular space between the drive shaft 12 and the side walls of the open core 24.

There are spanner holes or openings 36 provided in the disc flange 34, and these receive prongs of a standard spanner tool (not shown) that can be used for tightening and loosening the retaining nut 30.

As shown, e.g., in FIG. 5, the retaining nut 30 seats up inside the recess of the concave face 26 of the spacer disc 20, so that neither the retainer nut nor the drive shaft of the grinder project out beyond the plane of the cut-off disc. The tool can now be held so that the cut-off disc is flush with any flat workpiece surface, and can cut material away from that surface without gouging or cutting away material from below that surface.

Additionally, the central opening of the washer or insert 28 is smaller in diameter than the open core 24. This guards against the spacer disc 20 being inadvertently installed inverted, i.e., upside-down on the angle grinder. The tubular threaded nut portion 32 of the retaining nut 30 will fit into the core 24, but will not fit through the opening in the insert 28, which is dimensioned instead only to admit the grinder drive shaft 12. Thus, installation of the spacer disc 20 and cut-off disc 16 cannot be completed if the spacer disc 20 is inverted on the grinder.

Other shapes of the spacer body and other configurations of the retainer nut could be employed to the same effect as in this preferred embodiment, and other suitable materials could be used for the spacer body, the insert, and the retaining nut.

While the present invention has been described with reference to a specific preferred embodiment, it should be understood that the invention is not limited to that precise embodiment. Rather, many modifications and variations would present themselves to persons skilled in the art without departure from the scope and spirit of this invention, as defined in the appended claims.

I claim:

1. An arrangement for securing a cut-off disc onto a drive shaft of a hand-held power grinder device, in which a backing plate is secured at a predetermined position on said shaft; the arrangement comprising:
a spacer disc adapted to be positioned on said shaft and having a proximal face adapted to be placed against the backing plate and a distal face adapted to be positioned against a proximal side of the cut-off disc, the spacer disc including a spacer body having an open core into which the shaft passes, a distal side defining said distal face, said distal side being concave, and a durable rigid annular insert embedded in said spacer body at said proximal face thereof and having a central aperture coaxial with the open core of said spacer body; and
a flanged retainer nut which is adapted to be secured onto a distal end of said shaft and fitting within the open core of said spacer disc, and having a flange at the distal end thereof adapted to secure against a distal side of said cut-off disc such that the flange of the nut and the distal end of the shaft are positioned at or proximally of the plane of said cut-off disc.

2. The arrangement of claim 1 wherein said spacer body is formed of a semi-rigid synthetic plastic resin material.

3. The arrangement of claim 1 wherein spacer body has a tapered circumferential surface.

4. The arrangement of claim 1 wherein said retainer nut includes a female threaded tubular portion and disc flange affixed at a distal end of said tubular portion.

5. The arrangement of claim 4 wherein said disc flange has openings therein adapted to receive a spanner tool.

6. The arrangement of claim 1 wherein said spacer disk has a thickness between its proximal and distal faces of between a half inch and an inch.
